(19) United States
(12) Patent Application Publication
(10) Pub. No.: US 2021/0204753 A1
(43) Pub. Date: Jul. 8, 2021

(54) KEBAB BAKING OVEN

(71) Applicant: FIMAK FIRIN MAKINALARI IMALATI SANAYI VE TICARET ANONIM SIRKETI, Konya (TR)

(72) Inventor: Mehmet OZPINAR, Konya (TR)

(21) Appl. No.: 16/081,100

(22) PCT Filed: May 8, 2017
(86) PCT No.: PCT/TR2017/050177

§ 371 Date: Aug. 30, 2018

(51) Int. Cl. A47J 37/06; F24C 15/16

(52) U.S. Cl. CPC A47J 37/0629; F24C 15/325; F24C 15/164

(57) ABSTRACT

The invention particularly relates to a portable kebab oven (F) which is going to be used for making kebab of the meat of the animals such as lamb and kid, which is electrically driven and which will homogeneously bake the whole kebab.

### TECHNICAL FIELD

Invention relates to kebab baking ovens wherein all type of meats such as lamb and kid as small cattle are cooked.

The invention particularly relates to a portable kebab oven which is going to be used for making kebab of the meat of the animals such as lamb and kid, which is electrically driven and which will homogeneously bake the whole kebab.

### STATE OF THE ART

Nowadays, meats of animals such as sheep/lamb and goat/kid as small cattle are cooked to make kababs in the ovens. While preparing kebab, the meats without giblets of the animal which is not completely partitioned, having cooked are served.

In recent implementations, these kebabs are generally made in stone ovens that are called black oven. In these black ovens; temperature value cannot be adjusted as sensitive since wood or solid fuel are not used. Furthermore, because of the fact that any vapor mechanism does not exist in this type of ovens and heat does not equally affect the whole kebab, the tray in which kebab is baked is manually and constantly replaced inside the oven. The meat which is going to be cooked is slid into the oven and it is cooked while having approximated or moved away.

Black ovens prevent that the heat and the pressure inside to remain stable by letting the heat out during cooking because there is not an insulation element. Thus, extension of baking time and adjustment of baking are prevented.

Due to the fact that lower and upper temperature cannot be adjusted as sensitive, an homogenous cooking is not achieved and also carcinogenic effect may be formed because oil oozing out from the kebab (the meat) accumulates and burns and there is not a discharge system. Moreover, there are many negative factors that pests grow because of the fact that fuel (wood) is used in establishments and they occupy place and also chimney system is needed.

Due to the patent examination of present technique, in the registration of the utility model titled “improvement of kebab baking oven with lift mechanism” with “2010/08730” application number, it is explained as: “The invention relates an improvement of kebab baking oven with lift. This kebab baking oven which is the subject of the invention comprises rails that are made out from profile sticks that are fixed to the right and left side of the inner body of the cauldron; bearings located in the right and the left side which are fixed to the part between locomotive pan and the mirror providing the reciprocal movement of the carrying part without deviating to the right or left through those rails; mirror; carrying part; draft arm fixed in the triangle dimension if an edge is another edge of the carrying part which is fixed to the locomotive pan; a triangle dimension of which one edge is fixed to the draft arm and another edge is fixed to the upper cover of the oven; an upper cover which carries the lift part and all the parts thereon”

These problems that are explained above and inadequacy of solutions for these problems reveal that an improvement for kebab baking ovens is needed.

### BRIEF DESCRIPTION OF THE INVENTION

Main purpose of the invention is to product an electrical, portable kebab oven in which the whole surface of the kebab is baked and which is going to be used in making the meats of the animals such as lamb and kid.

A purpose of the invention is to place the meat to be cooked inside the oven by sliding the pan on which the meat is put, by means of a rail and to provide it to be easily took out from the oven.

A different purpose of the invention is to minimize heat loss by locating heat resistant stones to the upper edges and other edges of the oven which is in dome-shaped. Therefore, energy is saved and kebab is served fast.

Another different purpose of the invention is to homogenously cook the kebab by heating is implemented by ceramic resistances in electrical oven implementations and by individually adjusting lower and upper temperature values. Furthermore, measuring temperature values as sensitive is provided by means of thermocouples.

Another purpose of the invention is to produce an oven which is controlled by a control system which can gradually increase lower and upper temperature values and which can automatically control temperature and moisture without a rotating system.

Another purpose of the invention is to prepare a decent kebab by discharging the oil which is accumulated inside the cooking pan through a discharge channel. Furthermore, excess vapor to be formed inside the oven is discharged to the outside by means of automatic valve system and a safe cooking is provided.

### BRIEF DESCRIPTION OF THE FIGURES

Figures and drawings that are explained below should be evaluated together for the invention and its advantages to be understood better.

FIG. 1; is the front perspective view of kebab oven which is the subject of the invention.

FIG. 2; is the external part of the door of the kebab oven, which is the subject of the invention, in open position.

FIG. 3; is the view of the cooking pan, kebab fixing elements when the door of the kebab oven, which is the subject of the invention, is in open position.

FIG. 4; is the perspective view of the cooking and temperature control mechanism located in the rear side of kebab oven which is the subject of the invention.

FIG. 5; is the side perspective view of valve mechanism of the kebab oven which is the subject of the invention.

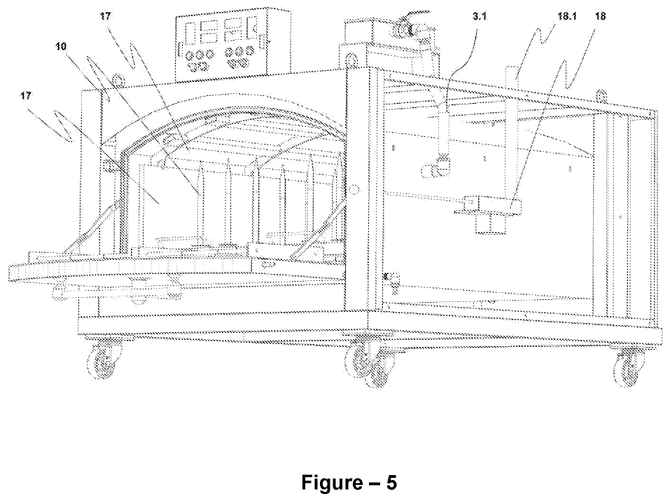

FIG. 6; is the perspective view of two-fold model of lamb baking oven which is the subject of the invention.

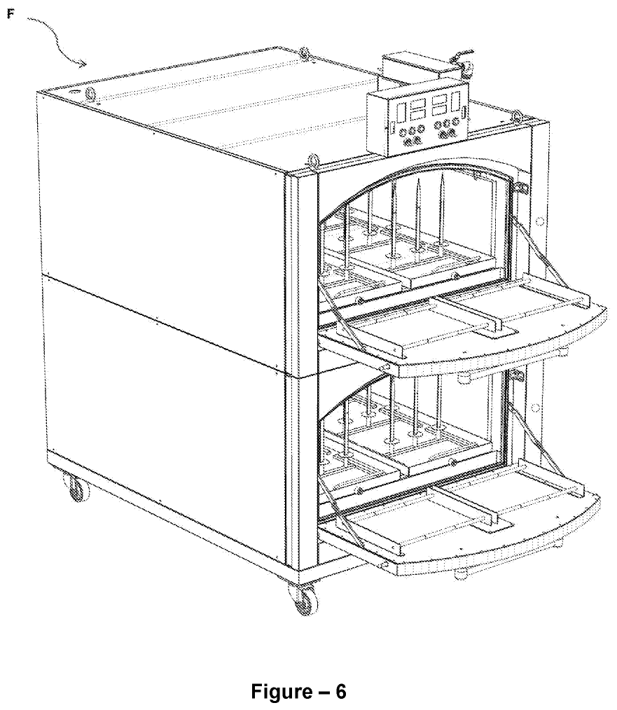

### REFERENCE NUMBERS

### F-Kebab Oven

1. Door
   1.1. Lock catch
2. Stand
   2.1. Wheel
3. Incense box
   3.1. Incense carrying element
4. Control panel
5. Oil discharge element
6. Hook
7. Rail mechanism
8. Channel
9. Pan
10. Fixing element
11. Vapor mechanism
12. Upper resistance
13. Lighting
14. Upper thermocouple
15. Lower resistance
16. Lower thermocouple
17. Stone
18. Valve mechanism
   18.1. Valve discharge pipe

It is unnecessary to scale the drawings and some details that are not necessary to understand the present invention may be ignored. Furthermore, the elements that are at least substantially identical to one another or the elements having at least substantially identical functions are designated with the same numbers.

### DETAILED DESCRIPTION OF THE INVENTION

In the detailed disclosure below, preferred configurations of kebab baking oven (F) which is the subject of the invention are explained as so they won't create any limitative effect for the subject to be understood better.

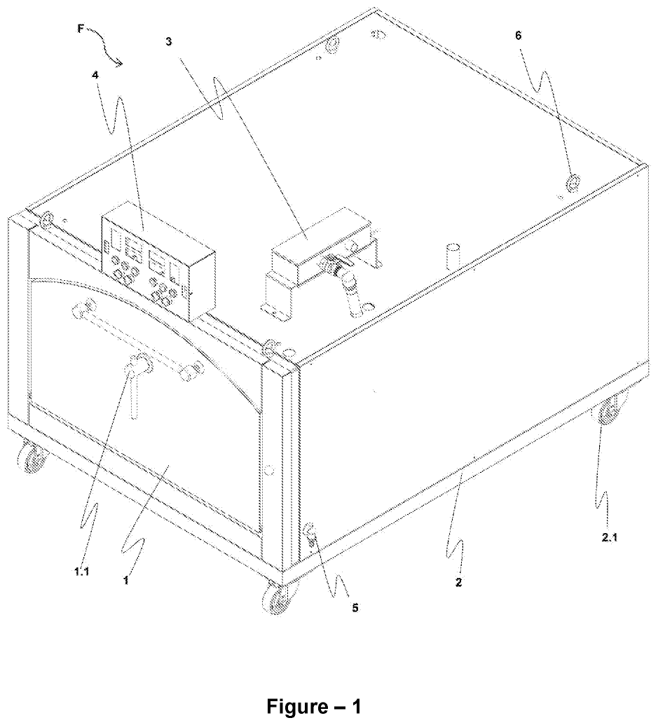

FIG. 1 shows the front perspective view of kebab oven (F) which is the subject of the invention. There is a door (1) preventing the temperature and pressure transition to the outer environment by hermetically closing the outlet of the kebab oven (F). Aforementioned door (1) has an insulated structure. There is a lock catch (1.1) that is held by the user for closing the door (1) while a product is put inside kebab oven (K) or took out. Aforementioned lock catch (1.1) is locked by rotating the bar which is mechanically placed thereon. There is a stand serving as frame which is located on kebab oven (1). Preferably, there is at least one wheel (2.1) on the edges of the lower part of said stand (1) for carrying kebab oven (F).

Preferably, an incense box (3) is located on the upper part of kebab oven (F) for flavoring. The contact beyween said incense box (3) and kebab oven (F) is provided by means of incense carrying element (3.1). Again, a control panel (4) which makes the necessary adjustment for desired lower and upper temperature inside said kebab oven and which provides present (instant) temperature values inside the oven to be seen is located on kebab oven (F). Kebab is cooked as desired by controlling kebab oven (4) by means of buttons located on control panel.

There various hooks (6) on the upper part of the kebab oven (F) to be easily carried or not to be damaged during carrying.

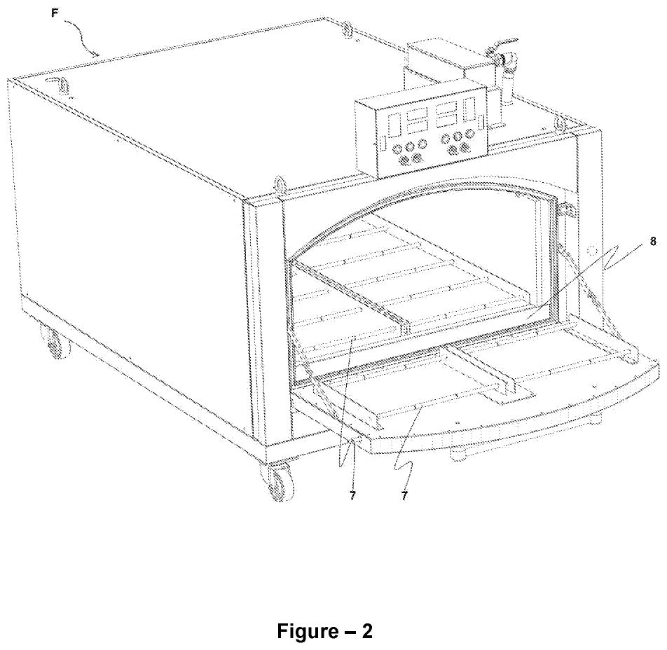

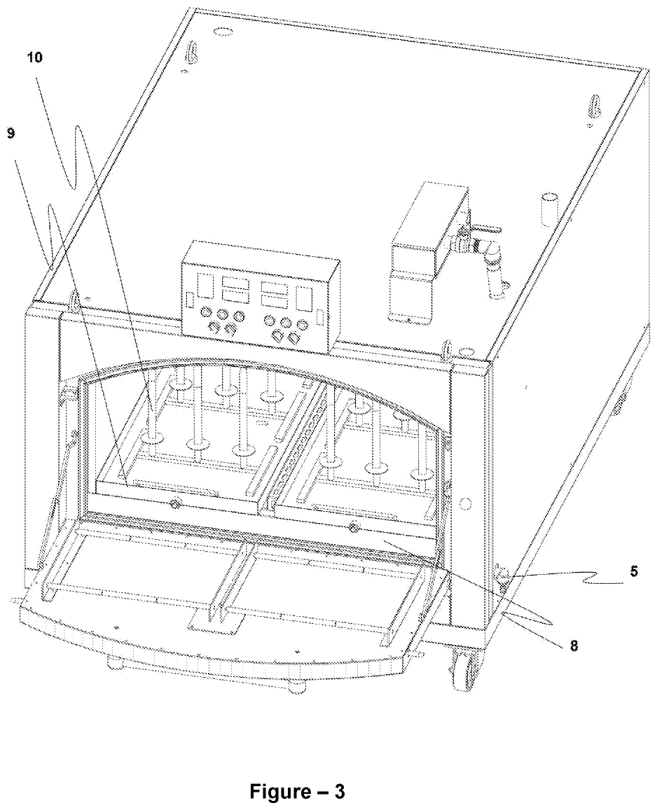

FIG. 2 and FIG. 3 show the view of internal part of kebab oven (F) when its door (1) is in open position. There is a rail mechanism (7) comprised of a various number of cylindrical metal providing pans (10) in which kebab is put, to be easily placed into the oven or took out from the oven. Said rail mechanism (7) comprises of multiple elements in metal pipe shape inside the oven. There are various number of fixing element (10) providing meats to stand upright and stabile on the pans (10) which are slid into the oven by rail mechanism (7). A channel (8) is constituted on the front side of the oven for discharge of oil oozing out from kebab which is cooked inside pan (10). In FIG. 1, a channel (8) is in contact with oil discharge element (5) located in the outer part of kebab oven (F) and oil is discharged from oven by means of oil discharge element (5).

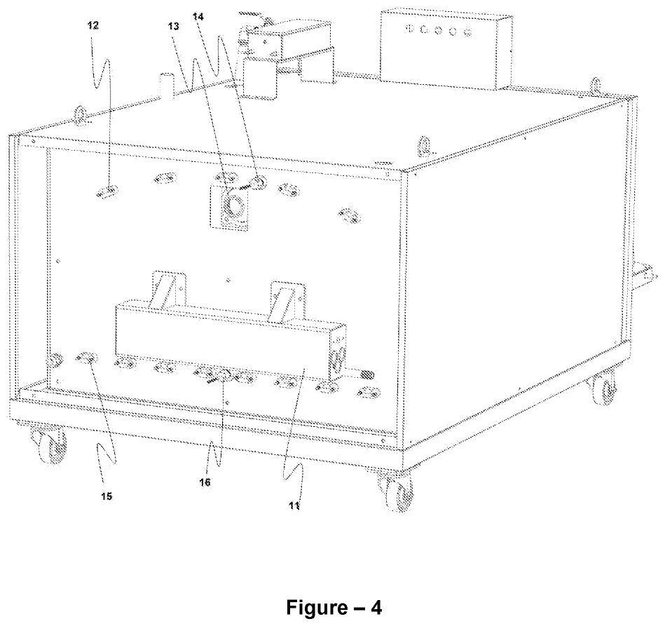

FIG. 4; shows perspective view of cooking and temperature control mechanism located in the rear side of kebab oven (F) which is subject of the invention. Various number of upper resistances (12) providing heat to the upper part of said kebab oven (F) are located. Upper thermocouple (14) transfers data to control center (4) by measuring temperature inside the oven generated by upper resistances (12). Various lower resistances (15) providing temperature to the lower part of kebab oven (F) are located. Lower thermocouple (16) transfers data to the control center (4) by measuring the temperature generated by lower resistances (15) inside the oven. External part of said kebab oven (F) is lightened by means of a lighting (13).

There is a vapor mechanism (11) which is located in the rear side of kebab oven (F) providing the meats to be cooked homogeneously by moistening during cooking. Adjustment of said vapor mechanism is made by means of control panel (4).

There is a perspective view of stones (17) by which internal and external sides of valve mechanism (18) located on the side of kebab oven (F) which is the subject of the invention. Excess vapor which is formed inside the oven is discharged by means of valve mechanism (18). The contact of valve mechanism (18) with outer environment is provided by means of valve discharge pipe (18.1).

Internal side of the kebab oven (F) is dome-shaped and heat loss is minimized by covering upper and other edges with heat resistant stones (17). Therefore, energy is saved and kebab is served fast. Said stones (17) are heat resistant and they homogenously dissipate heat on the whole surface of kebab due to its heat retention.

1. Invention is an electrical kebab oven (F) wherein all type of meats, particularly lamb and kid as small cattle, are cooked which comprises a door (1) preventing temperature and pressure transition to the outer environment and a stand (2) serving as a frame on which it is located, is characterized in that; it comprises
A control panel (4) which makes the necessary adjustment for desired lower and upper temperature inside said kebab oven (F) and which provides present (instant) temperature values inside the oven to be seen,
At least one rail mechanism (7) comprises of cylindrical metal which provides pans (10), in which kebab is put, to be put into the oven or to be took out from the oven,
At least one fixing element (10) which provides meats to stand upright and stabile on pans (10) which are slid into the oven by means of rail mechanism (7),
A vapor mechanism (11) which is located in the rear side of said kebab oven (F) providing meats to be homogenously cooked by moistening,
At least one upper resistance (12) providing heat to the upper part of said kebab oven (F) and at least one lower resistance (15) providing heat to the lower part,
Stones (17) laid to the inner sides of the edges on the outer part of door (1) of kebab oven (F) for radiating heat homogenously to the whole surface of kebab oven, retaining heat, providing insulation to the oven,
A valve mechanism (18) through which excess vapor that is formed inside said kebab oven (F) is discharged.

2. According to claim 1, a kebab oven (F) which is characterized in that; it comprises at least one wheel (2.1) individually located on the edges of the lower side of said stand (2) which provides kebab oven (F) to be carried.

3. According to claim 1, a kebab oven (F) which is characterized in that; it comprises an incense box (3) preferably located on the upper side of said kebab oven (F) for flavouring.

4. According to claim 1, a kebab oven (F) which is characterized in that; it comprises a channel (8) constituted on the front side of the oven for discharge of the oil oozing out from the kebab being cooked inside a pan (9).

5. According to claim 1, a kebab oven (F) which is characterized in that; it comprises an oil discharge element (5) from which oil oozing out of kebab flows out, which is located on the outer side of kebab oven (F) and which contacts with said channel (8).

6. According to claim 1, a kebab oven (F) which is characterized in that; it comprises at least one hook (6) to be carried easily and not to be damaged during carrying.

7. According to claim 1, a kebab oven (F) which is characterized in that; it comprises an upper thermocouple (14) transferring data to the control center by measuring the temperature generated by said upper resistances (12) inside the oven.

8. According to claim 1, a kebab oven (F) which is characterized in that; it comprises a lower thermocouple (16) transferring data to the control center by measuring the temperature generated by said lower resistances (15).

9. According to claim 1, a kebab oven (F) which is characterized in that; it comprises a valve discharge pipe (18.1) providing valve mechanism (18) to come into contact with outer environment.
